(19) United States
(12) Patent Application Publication
(10) Pub. No.: US 2025/0135437 A1
(43) Pub. Date: May 1, 2025

(54) METHOD FOR FABRICATING LAYERED SORBENT FILMS USING ADHESIVE

(71) Applicant: ARIZONA BOARD OF REGENTS ON BEHALF OF ARIZONA STATE UNIVERSITY, Scottsdale, AZ (US)

(72) Inventors: Matthew GREEN, Phoenix, AZ (US); John CIRUCCI, Scottsdale, AZ (US); Klaus LACKNER, Paradise Valley, AZ (US); Jae Sang LEE, Tempe, AZ (US)

(21) Appl. No.: 18/692,247

(22) PCT Filed: Sep. 14, 2022
(86) PCT No.: PCT/US2022/043427

§ 371 Date: Mar. 14, 2024

Related U.S. Application Data
(60) Provisional application No. 63/244,142, filed on Sep. 14, 2021.

(51) Int. Cl. B01J 20/28; B01D 53/02; B01J 20/26; B01J 20/30

(52) U.S. Cl. CPC B01J 20/28035; B01D 53/02; B01J 20/261; B01J 20/28004; B01J 20/2803; B01J 20/3042; B01D 2253/202; B01D 2253/304; B01D 2257/504; B01D 2258/06

(57) ABSTRACT

A method for fabricating a layered sorbent film is disclosed. The method includes forming a first sorbent layer by adhering a particulate sorbent material to a first adhesive surface of an adhesive film, the adhesive film further including a second adhesive surface coupled to a sacrificial liner. The method also includes removing the sacrificial liner from the adhesive film by exposure to a release medium, uncovering the second adhesive surface, and then forming a second sorbent layer by adhering the particulate sorbent material to the uncovered second adhesive surface. The method may also include separating a first release liner from the first adhesive surface of the adhesive film, uncovering the first adhesive surface. The sacrificial liner may be sufficiently rigid that while the sacrificial liner is coupled to the second adhesive surface, the first release liner may be removed from the adhesive film without causing mechanical damage.

### RELATED APPLICATIONS

This application claims the benefit of U.S. provisional patent application 63/244,142, filed Sep. 14, 2021, titled “Method for Fabricating Layered Sorbent Films Using Adhesive,” the entirety of the disclosure of which is hereby incorporated by this reference.

### TECHNICAL FIELD

Aspects of this document relate generally to fabricating sorbent films.

### BACKGROUND

The need for technologies to remove carbon dioxide from ambient air has been well established. In addition to conservation, reduced-carbon processes, and on-site capture efforts, a significant amount of carbon dioxide will need to be removed from the atmosphere to avoid a looming climate change crisis. Nevertheless, the technologies are still new and the early air capture processes require large amounts of energy to operate. Since the carbon dioxide in the ambient air is very dilute, atmospheric CO₂ collectors can quickly overrun a tight energy budget for drawing in and processing air in bulk.

A promising technology that is well adapted for capturing dilute atmospheric carbon dioxide in an energy efficient manner is passive direct air capture (hereinafter “passive DAC”) which is distinguished from other DAC technologies which require additional energy for the forced convection of air. Air contactor surfaces that comprise sorbent materials are exposed to passive atmospheric air flows, capturing carbon dioxide with the sorbent material to be released within an appropriate context for further processing, use, and/or storage.

There is a diverse range of sorbent materials that can be used for the uptake of CO₂ or other substances. However, many of these materials have physical properties that make it impossible or impractical to shape them into linear or sheet-like structures. For example, in many cases, the material is too brittle to be shaped in such a fashion. In some cases, the material experiences a substantial change in shape when exposed to moisture and/or heat, creating stresses that limit all dimensions to a short scale. This is particularly problematic for materials that operate on a moisture- or thermal-swing, and are repeatedly exposed to these stresses in the course of normal operation.

Some of these materials have excellent sorbent characteristics but need some structural support to be exposed to airflow without getting entrained in the gas stream or dropped from the contactor during operation. Many of these materials can only be produced as fine powders, beads, or pellets.

Another complication is the cyclical nature of the operation of these capture devices. Since devices comprising sorbent materials repeatedly undergo various regeneration steps, it is important that the processes used to recover the sorbate (i.e., CO₂) from the sorbent do not spend too much energy or require a heavy support structure. For example, in the case of a thermal swing sorbent material, the passive support structure repeatedly goes through heating and cooling cycles without directly contributing to the sorbate release, losing heat in the process. These sorbent materials are highly relevant for DAC which requires sorbents to be exposed to the air. The specific energy requirement of a thermal swing DAC system increases with increasing thermal mass, hence it is desired to achieve a high sorbent weight fraction over the total supported material mass, while also efficiently exposing these powders, beads, and/or pellets to the ambient air flows.

### SUMMARY

According to one aspect, a method for fabricating a layered sorbent film includes removing a second release liner releasably coupled to a second adhesive surface of an adhesive film, uncovering the second adhesive surface. The adhesive film further includes a first adhesive surface opposite the second adhesive surface and a first release liner releasably coupled to the first adhesive surface. The method further includes coupling a sacrificial liner to the uncovered second adhesive surface of the adhesive film. The sacrificial liner is sufficiently rigid that while the sacrificial liner is coupled to the second adhesive surface, the first release liner may be removed from the first adhesive surface of the adhesive film without causing mechanical damage to the adhesive film. The method includes removing the first release liner releasably coupled to the adhesive film, uncovering the first adhesive surface of the adhesive film, as well as forming a first sorbent layer by adhering a particulate sorbent material to the uncovered first adhesive surface of the adhesive film. The method further includes removing the sacrificial liner from the adhesive film by exposing at least the sacrificial liner to a release medium, uncovering the second adhesive surface, and then forming a second sorbent layer by adhering the particulate sorbent material to the uncovered second adhesive surface of the adhesive film. The particulate resin material is functionalized polystyrene resin beads having a diameter less than 1 mm.

Particular embodiments may comprise one or more of the following features. The method may also include uncovering a third adhesive surface of a second adhesive film. The second adhesive film may further include a fourth adhesive surface opposite the third adhesive surface, and a second sacrificial liner coupled to the fourth adhesive surface. The method may include adhering the uncovered third adhesive surface of the second adhesive film to one of the first sorbent layer and the second sorbent layer coupled to the first adhesive film. The method may also include removing the second sacrificial liner from the second adhesive film by exposing at least the second sacrificial liner to a second release medium, uncovering the fourth adhesive surface. The method may include forming a third sorbent layer by adhering the particulate sorbent material to the uncovered fourth adhesive surface of the second adhesive film. The adhesive film may be composed of a single layer of an adhesive. The adhesive film may include a thin film substrate having a first side and a second side opposite the first side. The adhesive film may further include a first adhesive layer bonded to the first side and a second adhesive layer bonded to the second side. The first and second adhesive layers may form the first and second adhesive surfaces of the adhesive film, respectively. The sacrificial liner may include polyvinyl alcohol and/or the release medium may be water. The method may also include perforating the adhesive film before the first release liner has been removed such that the adhesive film may include a plurality of apertures allowing an air flow to pass through.

According to another aspect of the disclosure, a method for fabricating a layered sorbent film includes forming a first sorbent layer by adhering a particulate sorbent material to a first adhesive surface of an adhesive film. The adhesive film further includes a second adhesive surface opposite the first adhesive surface, and a sacrificial liner coupled to the second adhesive surface. The method also includes removing the sacrificial liner from the adhesive film by exposing at least the sacrificial liner to a release medium, uncovering the second adhesive surface. Finally, the method includes forming a second sorbent layer by adhering the particulate sorbent material to the uncovered second adhesive surface of the adhesive film.

Particular embodiments may comprise one or more of the following features. The method may also include separating a first release liner from the first adhesive surface of the adhesive film, uncovering the first adhesive surface. The sacrificial liner may be sufficiently rigid that while the sacrificial liner is coupled to the second adhesive surface, the first release liner may be removed from the first adhesive surface of the adhesive film without causing mechanical damage to the adhesive film. The first release liner may be also the sacrificial liner. The method may also include removing a second release liner releasably coupled to the second adhesive surface of the adhesive film, uncovering the second adhesive surface. The method may include coupling the sacrificial liner to the second adhesive surface of the adhesive film. The method may also include uncovering a third adhesive surface of a second adhesive film. The second adhesive film may further include a fourth adhesive surface opposite the third adhesive surface, and a second sacrificial liner coupled to the fourth adhesive surface. The method may include adhering the uncovered third adhesive surface of the second adhesive film to one of the first sorbent layer and the second sorbent layer coupled to the first adhesive film. The method may also include removing the second sacrificial liner from the second adhesive film by exposing at least the second sacrificial liner to a second release medium, uncovering the fourth adhesive surface. The method may include forming a third sorbent layer by adhering the particulate sorbent material to the uncovered fourth adhesive surface of the second adhesive film. The first adhesive surface and/or the second adhesive surface comprise pressure sensitive adhesive. The adhesive film may be composed of a single layer of an adhesive. The adhesive film may include a thin film substrate having a first side and a second side opposite the first side. The adhesive film may further include a first adhesive layer bonded to the first side and a second adhesive layer bonded to the second side, the first and second adhesive layers forming the first and second adhesive surfaces of the adhesive film, respectively. Exposing at least the sacrificial liner to the release medium may include submerging the sacrificial liner, the adhesive film, and the first sorbent layer in the release medium. The release medium may be a liquid. The sacrificial liner may include polyvinyl alcohol. The release medium may be water. The method may also include perforating the adhesive film before the first release liner has been removed such that the adhesive film includes a plurality of apertures allowing an air flow to pass through. The adhesive film may be between 10 μm and 250 μm thick. The particulate resin material may have a diameter less than 200 μm.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIGS. 1A and 1B are cross-sectional views of two embodiments of a layered sorbent film;

FIG. 2 is a process flow of a method for fabricating a layered sorbent film;

FIG. 3 is a process flow of a method for fabricating a layered sorbent film having additional layers;

FIG. 4 is a perspective view of a porous adhesive film;

FIGS. 5A and 5B are plots of the carbon dioxide uptake for layered sorbent films having two different thicknesses; and

FIG. 6 is a plot of the carbon dioxide uptake for layered sorbent films using porous and non-porous adhesive films.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

The need for technologies to remove carbon dioxide from ambient air has been well established. In addition to conservation, reduced-carbon processes, and on-site capture efforts, a significant amount of carbon dioxide will need to be removed from the atmosphere to avoid a looming climate change crisis. Nevertheless, the technologies are still new and the early air capture processes require large amounts of energy to operate. Since the carbon dioxide in the ambient air is very dilute, atmospheric CO₂ collectors can quickly overrun a tight energy budget for drawing in and processing air in bulk.

A promising technology that is well adapted for capturing dilute atmospheric carbon dioxide in an energy efficient manner is passive direct air capture (hereinafter “passive DAC”) which is distinguished from other DAC technologies which require additional energy for the forced convection of air. Air contactor surfaces that comprise sorbent materials are exposed to passive atmospheric air flows, capturing carbon dioxide with the sorbent material to be released within an appropriate context for further processing, use, and/or storage.

There is a diverse range of sorbent materials that can be used for the uptake of CO₂ or other substances. However, many of these materials have physical properties that make it impossible to shape them into linear or sheet-like structures. For example, in many cases, the material is too brittle to be shaped in such a fashion. However, some of these materials have excellent sorbent characteristics but need some structural support to be exposed to airflow without getting entrained in the gas stream or dropped from the contactor during operation. Many of these materials can only be produced as fine powders, beads, or pellets.

Another complication is the cyclical nature of the operation of these capture devices. Since devices comprising sorbent materials repeatedly undergo various regeneration steps, it is important that the processes used to recover the sorbate (here CO₂) from the sorbent do not spend too much energy or require a heavy support structure. For example, in the case of a thermal swing sorbent material, the passive support structure repeatedly goes through heating and cooling cycles without directly contributing to the sorbate release, losing heat in the process. These sorbent materials are highly relevant for DAC which requires sorbents to be exposed to the air. The specific energy requirement of a thermal swing DAC system increases with increasing thermal mass, hence it is desired to achieve a high sorbent weight fraction over the total supported material mass, while also efficiently exposing these powders, beads, and/or pellets to the ambient air flows.

Contemplated herein is a method for fabricating a layered sorbent film using adhesive. Small sorbent particles are attached to a thin adhesive film that is sticky on both sides, in order to support and expose them more readily to a gas flow without entraining them. Specifically, two or more layers of particulate sorbent material(s) are held together with one or more adhesive films of micron-scale thickness, to selectively absorb or adsorb a particular gas from a dilute stream, according to various embodiments.

There are a number of reasons why many otherwise attractive sorbent materials are not amenable to be shaped into long fibers or flat sheets. One reason is a substantial change in shape caused by changes in temperature or moisture, introducing high internal stresses that limit all dimensions to a short scale (e.g., millimeters or less, etc.). Another reason is brittleness. Creating particle-covered sheets provides enough stability that they can be exposed to gas flow and endure repeated regeneration cycles.

These lightweight adhesive films contemplated herein can hold a diverse range of particulate sorbent sizes and shapes, from powders to larger particles (e.g., beads, pellets, etc.), and facilitate their exposure to the air. The contemplated method and layered architecture arranges these particulate sorbent materials to have improved surface area and exposure for effective absorption of gas, while also securing them so they are not lost, even after multiple regeneration cycles. The regeneration cycle is an essential step to desorb CO₂ in a DAC making use of moisture swing sorbent materials, heat swing sorbent materials, or other similar sorbent materials.

The method contemplated herein is well-adapted for making sheet-like structures from sorbent materials that are otherwise limited in shape to small particles of various shapes and sizes. As will be discussed in greater detail below, the application of a sacrificial liner to the adhesive film allows a particulate sorbent material to be mounted on both sides of a thin adhesive film without ripping the film, resulting in mechanically stable structures having a high weight fraction of sorbent

Advantageous over conventional methods for utilizing particulate sorbent materials, the method contemplated herein is readily scalable for commercialization, and can be implemented quickly and inexpensively. All the materials, including the adhesive film and sacrificial liner, are easily accessible and affordable. The successful harvesting of atmospheric carbon dioxide, on the scale needed to have an environmental impact, will require greater efficiency and cost effectiveness than what is possible with previous approaches.

Furthermore, the contemplated methods may be applied to particulate sorbent materials of various sizes and shapes and can produce stable sorbent structures having a wide range of sizes, thicknesses, and shapes. Compared to other architectures, sorbent material attached to adhesive films using the contemplated methods has a fast mass transfer rate and high adsorption capacity at a low pressure drop in the incident airflow, according to some embodiments. The supported sorbent material in the contemplated layered sorbent films gives high performance even after exposure to repeated regeneration cycles, according to various embodiments.

Some embodiments of the resulting layered sorbent structures can withstand repeated direct exposure to hot steam without losing any of the particulate sorbent material. This exposure to steam facilitates driving the sorbate back off the sorbent particles, an necessary step in operating a DAC device, but sometimes the harshest step for the sorbent structures to endure.

It should be noted that while the following discussion of the contemplated methods and the resulting layered sorbent materials and structures is done in the context of capturing atmospheric carbon dioxide with a DAC device, these methods, materials, and structures may be adapted for use with other types of capture devices (e.g., forced air, etc.), other gas sources (e.g., industrial by-product, etc.), and other gases. Specifically, highly effective layered sorbent structures of various sizes, shapes, and thicknesses may be produced inexpensively from any particulate sorbent material known in the art, using the contemplated methods.

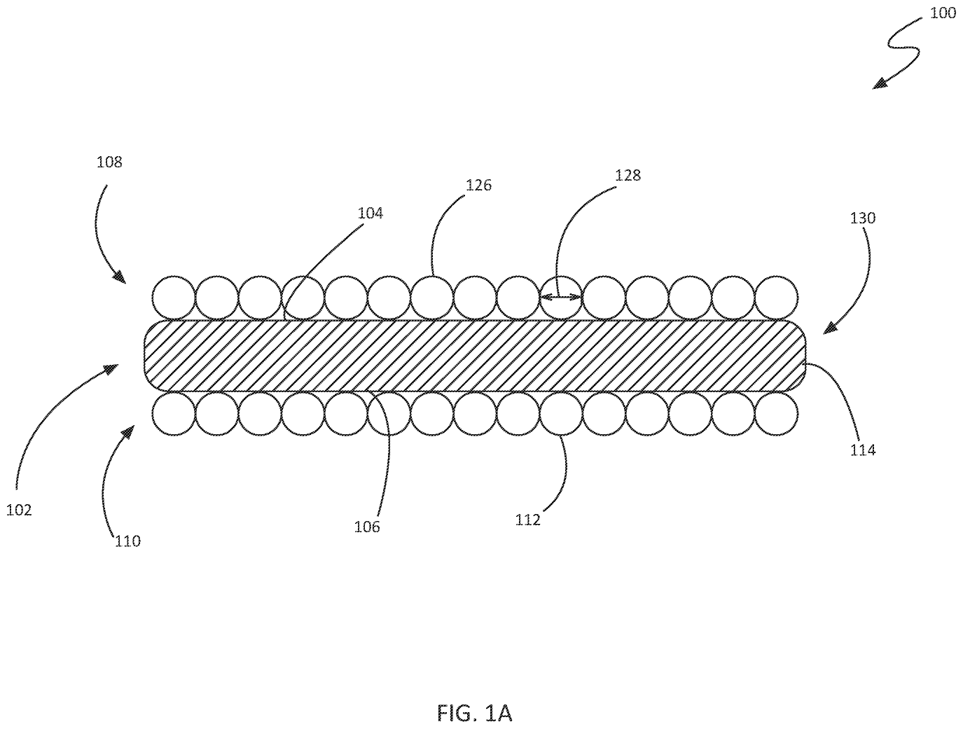

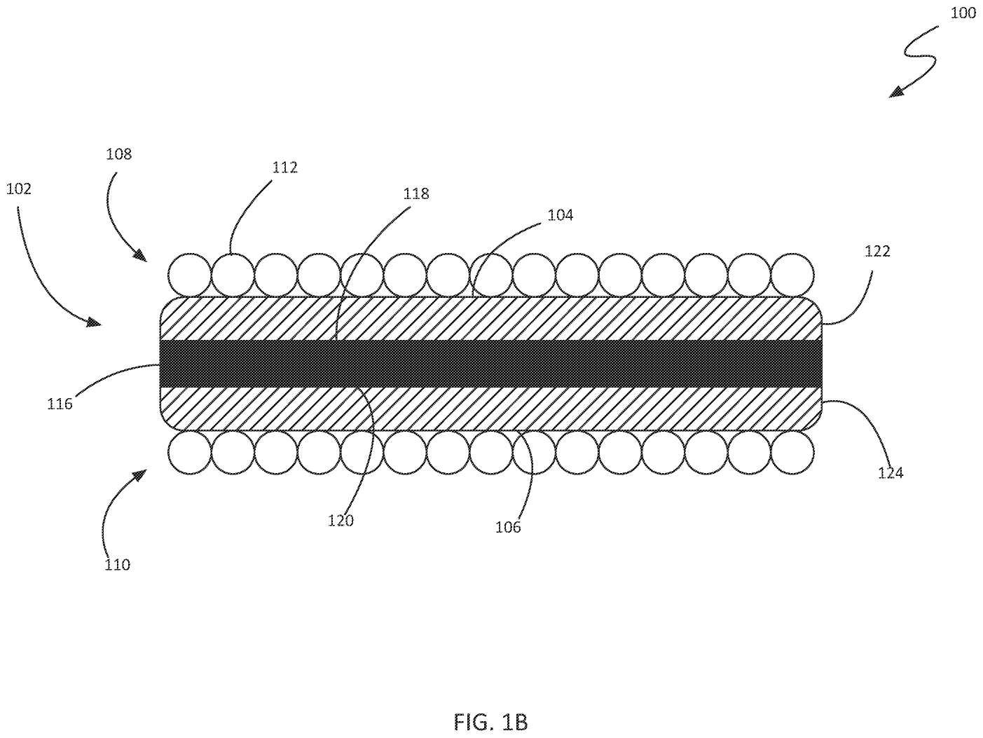

FIGS. 1A and 1B are cross-sectional views of two non-limiting examples of a layered sorbent film. As shown, the layered sorbent film 100 comprises an adhesive film 102 having a first adhesive surface 104 and a second adhesive surface 106 opposite the first adhesive surface 104. Adhered to each of these surfaces is a particulate sorbent material 112, forming a first sorbent layer 108 and a second sorbent layer 110, separated by the thin adhesive film 102, according to various embodiments.

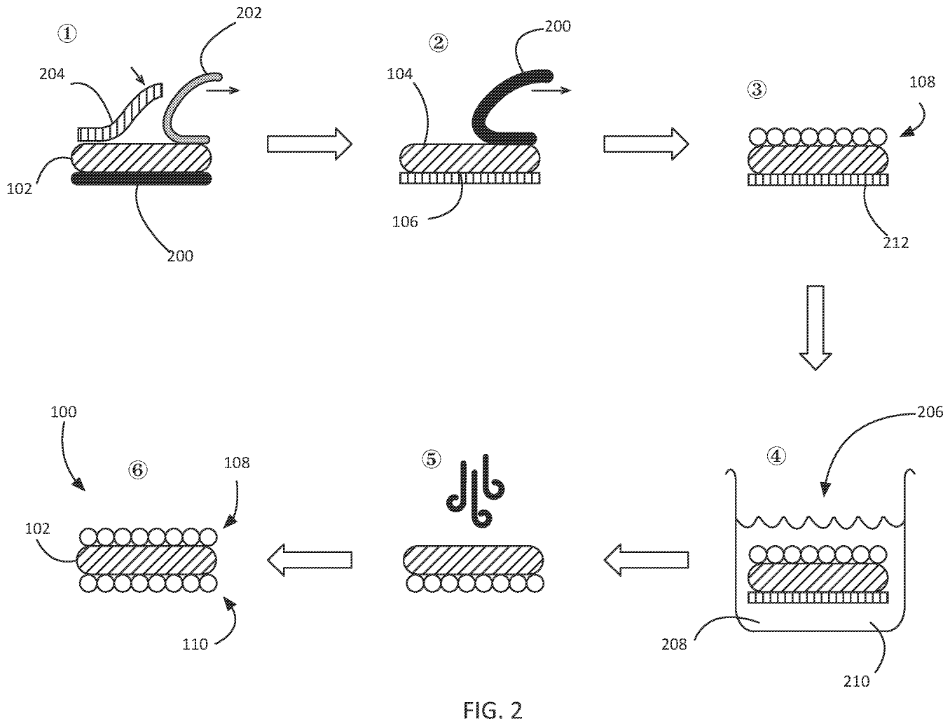

In the context of the present description and the claims that follow, an adhesive film 102 is a thin film that is sticky on both sides. In some embodiments, including the non-limiting example shown in FIG. 1A, the adhesive film 102 may be a single uniform layer of an adhesive material. According to various embodiments, the adhesive film 102 initially has release liners on both sides, protecting the first adhesive surface 104 and second adhesive surface 106. The “stickiness” can be exposed on one or both sides by selectively removing the release liners. As will be discussed below in the context of FIG. 2, these release liners can facilitate the use of very thin (and fragile) adhesive films 102.

According to various embodiments, adhesive films 102 may be composed of an elastic polymer. Examples include polyacrylate, polystyrene, polysiloxane, and the like. In some embodiments, the elastic polymer is used in conjunction with a tackifier resin. In some embodiments, the adhesive of the adhesive film 102 may curable. In other embodiments, the first adhesive surface 104 and the second adhesive surface 106 may comprise pressure sensitive adhesive 130. Those skilled in the art will recognize that the contemplated fabrication method may be adapted for use with other adhesive materials and adhesive films, both those known in the art and adhesives not yet developed, without departing from the spirit of the contemplated method for fabricating layered sorbent films 100.

According to various embodiments, the adhesive film 102 can have various thicknesses. In some embodiments, the thickness of the adhesive film 102 is micron-scale. For example, in one embodiment, the adhesive film 102 may be, at most, 250 μm in thickness. In another embodiment, the adhesive film 102 may be as thin as 12 μm. It is usually desirable to use the thinnest film which still provides sufficient structural strength and particle retention for the intended application (e.g., ultimate shape, use environment, severity and nature of the regeneration cycle for the sorbent material used, etc.). According to various embodiments, the lower limits of viable adhesive film 102 thickness will be dependent on the film composition. In many cases the adhesive film 102 will be thicker than 1 μm. In some embodiments, the thickness of the adhesive film 102 is between 10 μm and 500 μm thickness. The weight fraction of sorbent material relative to the total supported material mass is increased by decreasing the thickness (and therefore, mass) of the adhesive film 102. A thicker adhesive film 102 may enable the particulate sorbent material 112 to be more embedded or adhered, thereby resulting in a stronger bond, but this would come at the expense of reduced exposed surface area and increased overall mass. In one specific embodiment, using adhesive films 102 with thicknesses ranging from 12 μm to 250 μm has enabled a low ratio of sorbent mass over total supported material mass, without sacrificing too much stability, for a particular implementation and use environment. Of course, other applications or use environments for the fabricated layered sorbent film 100 may require the use of a thicker adhesive film 102.

As mentioned above, in some embodiments, the adhesive film 102 may be composed of a single layer 114 of adhesive material having a first adhesive surface 104 and a second adhesive surface 106. In other embodiments, including the non-limiting example shown in FIG. 1B, the adhesive film 102 may comprise a thin film substrate 116 having a first side 118 and a second side 120 opposite the first side 118. The thin film substrate 116 can provide needed stability or rigidity in embodiments where the desired adhesive material is not strong enough by itself to meet the needs of the layered sorbent film 100 within the desired thickness. As shown, the adhesive film 102 may also include a first adhesive layer 122 bonded to the first side 118 of the thin film substrate 116 and a second adhesive layer 124 bonded to the second side 120 of the thin film substrate 116. According to various embodiments, the first and second adhesive layers form the first and second adhesive surfaces of the adhesive film 102, respectively.

The size of the particulate sorbent material 112 used to form the sorbent layers can range from fine or crushed powders (e.g., grains less than 1 μm in diameter, etc.) to large particles (e.g., roughly 5 mm in diameter, etc.). As a specific example, in one embodiment, a functionalized polystyrene resin beads 126 may be used. As a specific example, in one embodiment, these beads 126 are sub-millimeter beads, with approximately 500 μm mean diameter. In another embodiment, the particulate sorbent material 112 may comprise functionalized polystyrene resin beads 126 having a diameter 128 less than 1 mm. In still other embodiments, the particulate sorbent material 112 may comprise a crushed sorbent resin powder having a grain size or diameter 128 ranging from 200 μm to 50 nm. Other embodiments may use beads, powders, or other particles made of strong base anionic resin. Still other embodiments may make use of other sorbents known in the art including, but not limited to, acrylate-based resins and vinyl-based resins. Representative particulate sorbent material 112 forms include, but are not limited to, spherical beads, extruded cylindrical pellets, precipitated crystals, and crushed powders.

FIG. 2 is a process flow of a non-limiting example of a method for fabricating a layered sorbent film 100 having two layers of sorbent material joined by a single layer of adhesive. As shown, the process begins with an adhesive film 102. In some embodiments, the adhesive film 102 may require some preparation to be compatible with the contemplated method. Specifically, in some embodiments, a sacrificial liner 204 is applied to the adhesive film 102. See ‘circle 1’.

According to various embodiments, the adhesive film 102 is prevented from sticking to random surfaces by covering the adhesive surfaces with protective release liners, a first release liner 200 and a second release liner 202. In some embodiments, the adhesive film 102 may have an “easy release liner” (i.e., the second release liner 202) on the second adhesive surface 106 and a “hard release liner” (i.e., the first release liner 200) on the first adhesive surface 104. In other typical applications for these adhesive films, the easy release liner is readily removed first to expose one side of adhesive for attachment to some solid surface which provides rigidity so that the hard release liner can subsequently be removed for the attachment of a second surface, resulting in the two surfaces being bonded to each other with the gap between them filled with a thin layer of adhesive. In these typical applications, the “hard release liner” provides the necessary rigidity to remove the softer “easy release liner” without damaging the thin adhesive film. Attaching the adhesive to the first object stabilizes the adhesive surface, making it easier to remove the hard release liner and presenting the other side of the adhesive to the second object without tearing or otherwise being damaged.

Unlike typical applications for these adhesive films 102, the methods contemplated herein call for the attaching of particulate sorbent material 112 to both sides. Thus, the adhesive film 102 is not stabilized after attaching sorbent to the “easy side”, making it difficult to remove the hard release liner from the other side without causing mechanical damage (e.g., ripping, tearing, stretching, deforming, breaking, warping, etc.).

According to various embodiments, this difficulty is overcome with the use of a sacrificial liner 204. In the context of the present disclosure and the claims that follow, a sacrificial liner 204, or sacrificial release liner 204, is a film or layer of material that has mechanical properties sufficiently similar to those of a conventional hard release liner of an adhesive film 102 that it may function in the same role, while also able to be removed from the adhesive film 102 through the application of a release medium 206, or otherwise having reversible adhesion properties. Specifically, the sacrificial liner 204 is sufficiently rigid that while the sacrificial liner 204 is coupled to the second adhesive surface 106, the first release liner 200 may be removed from the first adhesive surface 104 of the adhesive film 102 without causing mechanical damage to the adhesive film 102. In the context of the present description and the claims that follow, mechanical damage here refers to damage to the adhesive film 102 that would render the adhesive film 102 unsuitable for its intended purpose. It should be noted that this makes the threshold depend upon the intended application for the layered sorbent film 100. For example, in one embodiment where the layered sorbent film 100 is meant to be used in a DAC having very exacting standards with respect to device geometry, with sorbent components needing to fit together with narrow tolerances (e.g., layered sorbent films 100 having to collapse into a small enclosed volume for regeneration, etc.), a sacrificial liner 204 whose rigidity results in slight stretching of the adhesive film 102 when the first release liner 200 is removed would be unacceptable mechanical damage. On the other hand, in another embodiment where the layered sorbent film 100 can have some variability, unacceptable mechanical damage may be tearing, or the like.

As shown, in some embodiments, the second release liner 202 is removed to uncover the second adhesive surface 106, and replaced with a sacrificial liner 204. In other embodiments, the adhesive film 102 may be manufactured having two hard release liners, at least one of which is sensitive to a release medium (i.e., is a sacrificial liner 204).

Next, the first release liner 200 (i.e., the hard release liner) is removed. See ‘circle 2’. According to various embodiments, the first release liner 200 is releasably coupled to the adhesive film 102, and is removed to uncover the first adhesive surface 104. After the first adhesive surface 104 is uncovered, a first sorbent layer 108 is formed by adhering one or more particulate sorbent materials 112 to the uncovered first adhesive surface 104. See ‘circle 3’. The method used to adhere the particulate sorbent material 112 to the adhesive film 102 depends on the nature of the particulate sorbent material 112 and the type of adhesive film 102. For example, in one embodiment using very small sorbent grains in combination with a pressure sensitive adhesive 130, the first adhesive surface 104 may simply be gently pressed into a bed of the particulate sorbent material 112.

The sacrificial liner 204 is then removed from the adhesive film 102 by exposing it to a release medium 206. See ‘circle 4’. Release mediums 206 vary with the material used in the sacrificial liner 204, and may include, but are not limited to, solvents (e.g., water, etc.), heat, light, gases, liquids 208, and the like. As a specific example, in some embodiments the sacrificial liner 204 may be dissolved in water 210 by immersing at least the sacrificial liner 204 in a release medium 206, uncovering the second adhesive surface 106. Polyvinyl alcohol 212 is an example of a suitable sacrificial liner 204 which can be directly dissolved in water 210. In other embodiments, other materials able to be directly dissolved in water 210 may be used including, but not limited to, polyethylene glycol, polyacrylamides, polyacrylic acid copolymers, polysaccharides, and other water soluble polymers.

In some embodiments, the release medium 206 is water and the sacrificial liner 204 is composed of a water soluble material. In other embodiments, other release mediums 206 may be used, in conjunction with sacrificial liners 204 that they dissolve or otherwise remove without disturbing or exerting destructive force on the adhesive film 102. Any release medium 206 and sacrificial liner material pair known in the art may be used, so long as the release medium 206 does not degrade the adhesive film 102, whether it be a single layer of adhesive or adhesive layers sandwiching a thin film substrate. As a specific, non-limiting example, in one embodiment, the adhesive film 102 may comprise a thin film substrate 116 composed of polyethylene terephthalate, which is resistant towards a number of solvents that could be employed as release mediums 206 including, but not limited to, mild acids, hydrocarbons (e.g., aliphatic hydrocarbons, toluene, xylene), diethyl ether, glycols (e.g., diethylene glycol, propylene glycol), and alcohols (e.g., ethyl, isopropyl, methyl).

In some embodiments, the entire layered structure may be submerged or otherwise exposed to the release medium 206, while in other embodiments the exposure may be limited to the sacrificial liner 204. In a specific, non-limiting embodiment depicted in FIG. 1A, the adhesive film 102 with functionalized polystyrene resin beads 126 coated on one side and the sacrificial liner 204 on the other side is submerged in deionized water 210 at room temperature and washed 2-3 times. The release medium 206 is then removed from the layered structure. See ‘circle 5’, where the structure is dried by blowing air over it for one minute. After the sacrificial liner 204 has been removed, particulate sorbent material 112 is attached to the uncovered second adhesive surface 106 of the adhesive film 102. See ‘circle 6’. This results in forming a second sorbent layer 110, and creating a layered sorbent film 100 comprising two sorbent layers, with a layer of adhesive in between.

In some embodiments, the layered sorbent film 100 may be fabricated, starting with an adhesive film 102 whose two sides are covered by two release liners, one of which is then removed and replaced with a sacrificial liner 204. In other embodiments, the adhesive film 102 may be manufactured with the sacrificial liner 204 already in place on one of the adhesive surfaces of the adhesive film 102, such that the method for fabricating the layered sorbent film 100 may begin with the removal of the other release liner in preparation for forming the first sorbent layer 108.

In still other embodiments, more of this process may be incorporated with the manufacture of the adhesive film 102. For example, in some embodiments, the adhesive film 102 may be manufactured with a sacrificial liner 204 on the second adhesive surface 106, with the first adhesive surface 104 then adhered to the particulate sorbent material 112, negating the need for any release liner, sacrificial or otherwise, to protect the first adhesive surface 104.

In the non-limiting example shown in FIG. 2, the adhesive film 102 and sacrificial liner 204 are shown to be planar. In some embodiments, the adhesive film 102 and sacrificial liner 204 may be planar or substantially planar. In other embodiments, the adhesive film 102 may be stored as a roll, having a single release liner separating the first adhesive surface 104 from the second adhesive surface 106. In such embodiments, this single release liner (i.e., the first release liner 200) is separated from the first adhesive surface 104 as the adhesive film 102 is unrolled, and then subsequently removed from the second adhesive surface 106. In some embodiments, this solitary rolled liner may be a standard release liner. However, in other embodiments this solitary rolled liner may be a sacrificial liner 204. In other words, in some embodiments, the first release liner 200 may also be the sacrificial liner 204, which is first separated from the first adhesive surface 104 of the adhesive film 102, and then removed from the second adhesive surface 106 using the release medium 206 after the formation of the first sorbent layer 108.

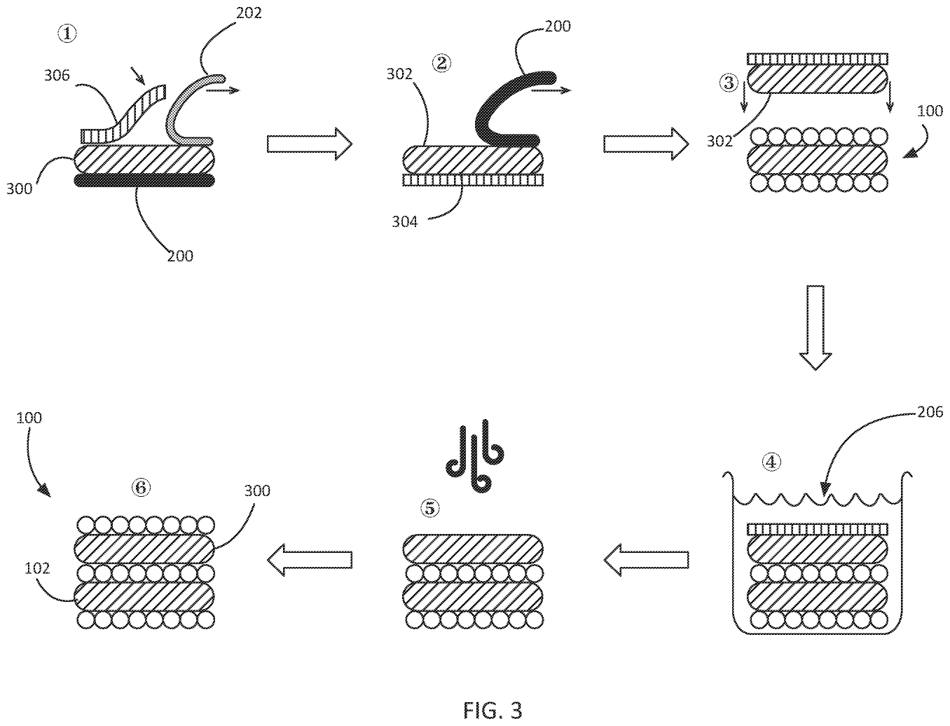

FIG. 3 is a process flow of a non-limiting example of a method for fabricating a layered sorbent film having additional layers of sorbent material joined by layers of adhesive film 102. Starting from the end of the process shown in FIG. 2, additional layers of adhesive and sorbent may be added, forming a “sorbent sandwich”. This facilitates the tuning of the total sorbent mass and weight ratio, improving performance without complicating the fabrication process or sacrificing the weight fraction of sorbent.

Many of the steps are similar to those shown in FIG. 2. As shown, a second adhesive film 300 may be prepared by replacing a liner with a second sacrificial liner 306. See ‘circle 1’. The third adhesive surface 302 of the second adhesive film 300 is uncovered, exposing the third adhesive surface 302. See ‘circle 2’. This second adhesive film 300 is then attached to one of the sorbent layers of the existing layered sorbent film (i.e., the product of FIG. 2). Specifically, the uncovered third adhesive surface 302 of the second adhesive film 300 is adhered to one of the first sorbent layer 108 and the second sorbent layer 110 coupled to the first adhesive film 102 (i.e., the product of FIG. 2). See ‘circle 3’.

Next, the second sacrificial liner 306 is removed from the second adhesive film 300 by exposing at least the second sacrificial liner 306 to a second release medium 308, uncovering the fourth adhesive surface 304. See ‘circle 4’. In a specific embodiment, the same materials used in the earlier process may be in use for the additional layers (e.g., submerged in distilled water at room temperature, washed 2-3 times, then dried by blowing air over it for one minute, etc.). See ‘circle 5’.

Finally, a third sorbent layer 310 is formed by adhering particulate sorbent material 112 to the uncovered fourth adhesive surface 304 of the second adhesive film 300, resulting in a layered sorbent film 100 having three sorbent layers. See ‘circle 6’. According to various embodiments, these steps can be repeated until the number of layers in the sorbent sandwich reaches the desired thickness, or a desired total sorbent mass has been achieved.

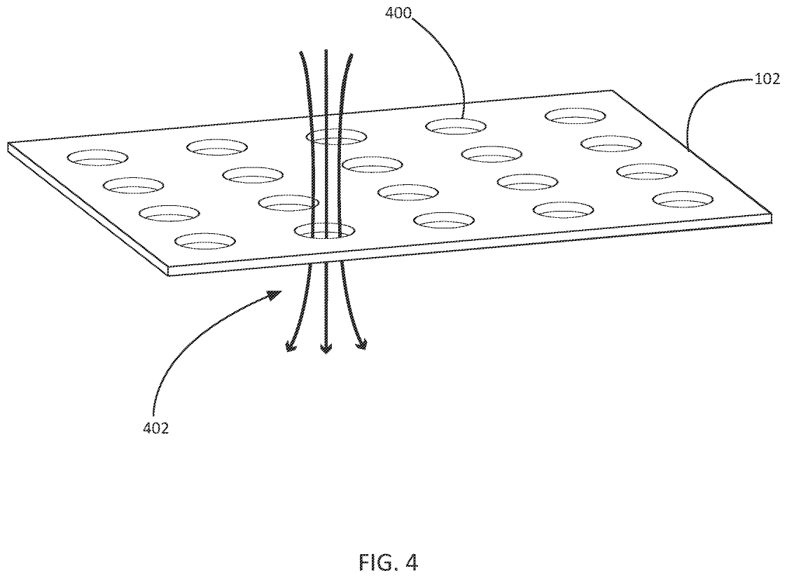

FIG. 4 is a perspective view of a non-limiting example of a porous adhesive film 102. In some embodiments, particularly embodiments where the layered sorbent film 100 has more than two sorbent layers, performance may be improved through the use of porous adhesive films 102 to allow better air flow 402 through the layered sorbent film 100. In some embodiments, the adhesive film 102 may be perforated at the time of manufacture. In other embodiments, conventional non-porous adhesive film 102 may be perforated before the first release liner 200 has been removed such that the adhesive film 102 comprises a plurality of apertures 400 allowing an air flow 402 to pass through. For example, in one embodiment, non-porous adhesive film 102 may be perforated using a hollow punch. Other embodiments may employ any other tool or method known in the art for perforating a thin film.

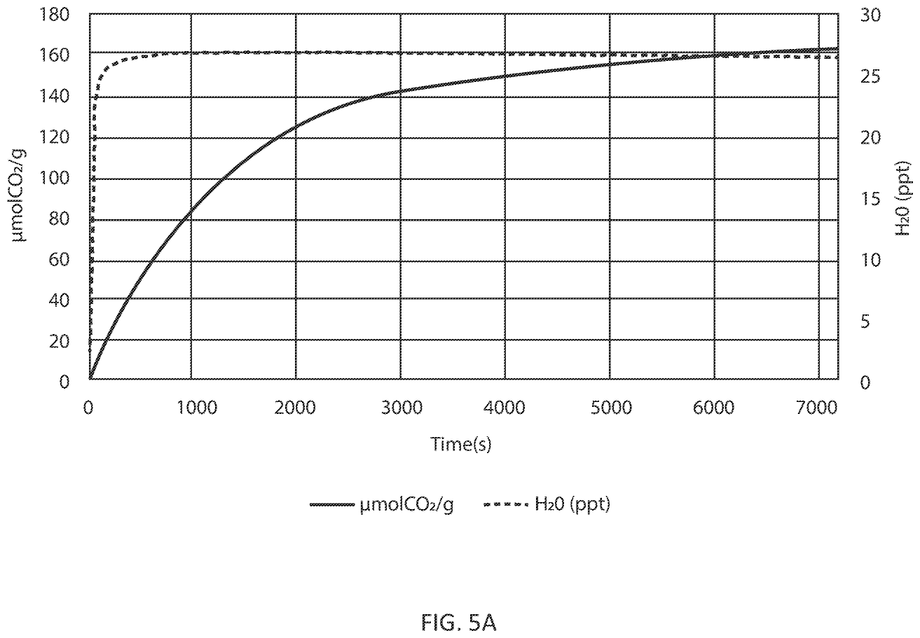

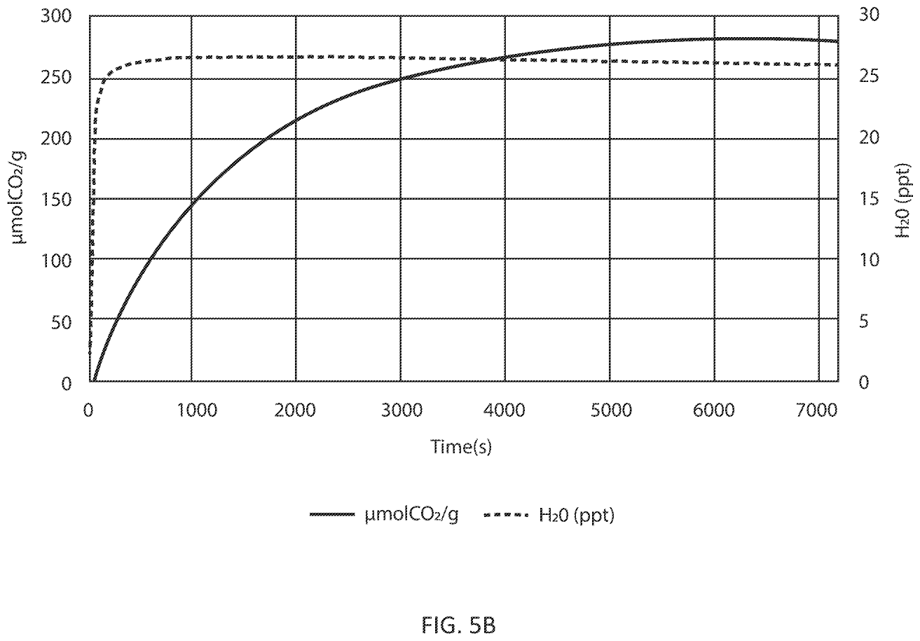

FIGS. 5A and 5B are plots of the carbon dioxide uptake for non-limiting examples of layered sorbent films 100 fabricated using the methods contemplated herein. Both plots have been normalized by the total sample mass. FIG. 5A shows the results for a layered sorbent film 100 made using an adhesive film 102 that is 250 μm thick. FIG. 5B shows the results for a layered sorbent film 100 made with an adhesive film 102 that is 25 μm thick. Both films employ functionalized polystyrene resin beads 126 as the sorbent material. As shown, the 25 μm version is able to capture significantly more carbon dioxide per gram of total mass than the 250 μm version. This is due to the higher weight fraction of sorbent.

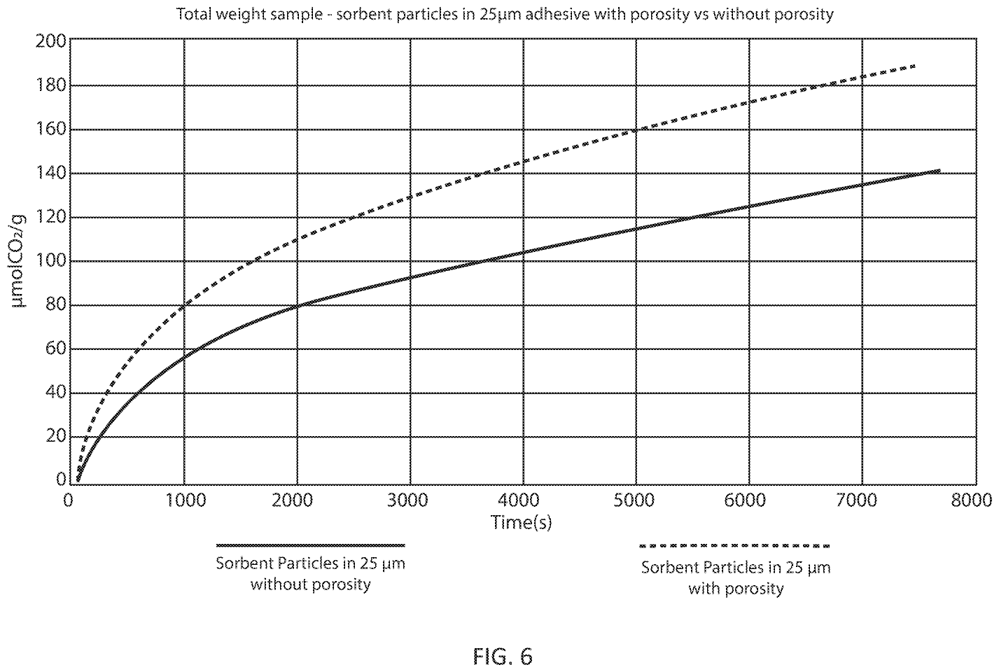

FIG. 6 is a plot of the carbon dioxide uptake results, normalized by the total sample mass, for two non-limiting examples of layered sorbent film 100 fabricated using the methods contemplated herein. Both layered sorbent films 100 were made using two layers 25 μm thick adhesive film 102 combined with three layers of functionalized polystyrene resin beads 126. The solid line shows the results for the layered sorbent film 100 made with non-porous adhesive film 102, while the dashed line shows the results for the layered sorbent film 100 made with adhesive film 102 having a plurality of apertures 400 (i.e., porous). As shown, the porous variation has better gas uptake performance compared with the non-porous variation, due to the increased exposure of the sorbent to the atmosphere.

Where the above examples, embodiments and implementations reference examples, it should be understood by those of ordinary skill in the art that other sorbents, adhesives, structures, and examples could be intermixed or substituted with those provided. In places where the description above refers to particular embodiments of methods for fabricating layered sorbent films, it should be readily apparent that a number of modifications may be made without departing from the spirit thereof and that these embodiments and implementations may be applied to other sorbent film fabrication methods as well. Accordingly, the disclosed subject matter is intended to embrace all such alterations, modifications and variations that fall within the spirit and scope of the disclosure and the knowledge of one of ordinary skill in the art.

What is claimed is:

1. A method for fabricating a layered sorbent film, comprising:
removing a second release liner releasably coupled to a second adhesive surface of an adhesive film, uncovering the second adhesive surface, the adhesive film further comprising a first adhesive surface opposite the second adhesive surface and a first release liner releasably coupled to the first adhesive surface;
coupling a sacrificial liner to the uncovered second adhesive surface of the adhesive film, wherein the sacrificial liner is sufficiently rigid that while the sacrificial liner is coupled to the second adhesive surface, the first release liner may be removed from the first adhesive surface of the adhesive film without causing mechanical damage to the adhesive film;
removing the first release liner releasably coupled to the adhesive film, uncovering the first adhesive surface of the adhesive film;
forming a first sorbent layer by adhering a particulate sorbent material to the uncovered first adhesive surface of the adhesive film;
removing the sacrificial liner from the adhesive film by exposing at least the sacrificial liner to a release medium, uncovering the second adhesive surface; and
forming a second sorbent layer by adhering the particulate sorbent material to the uncovered second adhesive surface of the adhesive film;
wherein the particulate resin material is functionalized polystyrene resin beads having a diameter less than 1 mm.

2. The method of claim 1, further comprising:
uncovering a third adhesive surface of a second adhesive film, the second adhesive film further comprising a fourth adhesive surface opposite the third adhesive surface, and a second sacrificial liner coupled to the fourth adhesive surface;
adhering the uncovered third adhesive surface of the second adhesive film to one of the first sorbent layer and the second sorbent layer coupled to the first adhesive film;
removing the second sacrificial liner from the second adhesive film by exposing at least the second sacrificial liner to a second release medium, uncovering the fourth adhesive surface;
forming a third sorbent layer by adhering the particulate sorbent material to the uncovered fourth adhesive surface of the second adhesive film.

3. The method of claim 1, wherein the adhesive film is composed of a single layer of an adhesive.

4. The method of claim 1, wherein the adhesive film comprises a thin film substrate having a first side and a second side opposite the first side, the adhesive film further comprising a first adhesive layer bonded to the first side and a second adhesive layer bonded to the second side, the first and second adhesive layers forming the first and second adhesive surfaces of the adhesive film, respectively.

5. The method of claim 1, wherein the sacrificial liner comprises polyvinyl alcohol and the release medium is water.

6. The method of claim 1, further comprising perforating the adhesive film before the first release liner has been removed such that the adhesive film comprises a plurality of apertures allowing an air flow to pass through.

7. A method for fabricating a layered sorbent film, comprising:
forming a first sorbent layer by adhering a particulate sorbent material to a first adhesive surface of an adhesive film, the adhesive film further comprising a second adhesive surface opposite the first adhesive surface, and a sacrificial liner coupled to the second adhesive surface;
removing the sacrificial liner from the adhesive film by exposing at least the sacrificial liner to a release medium, uncovering the second adhesive surface;
forming a second sorbent layer by adhering the particulate sorbent material to the uncovered second adhesive surface of the adhesive film.

8. The method of claim 7, further comprising:
separating a first release liner from the first adhesive surface of the adhesive film, uncovering the first adhesive surface;
wherein the sacrificial liner is sufficiently rigid that while the sacrificial liner is coupled to the second adhesive surface, the first release liner may be removed from the first adhesive surface of the adhesive film without causing mechanical damage to the adhesive film.

9. The method of claim 8, wherein the first release liner is also the sacrificial liner.

10. The method of claim 7, further comprising:
removing a second release liner releasably coupled to the second adhesive surface of the adhesive film, uncovering the second adhesive surface; and
coupling the sacrificial liner to the second adhesive surface of the adhesive film.

11. The method of claim 7, further comprising:
uncovering a third adhesive surface of a second adhesive film, the second adhesive film further comprising a fourth adhesive surface opposite the third adhesive surface, and a second sacrificial liner coupled to the fourth adhesive surface;
adhering the uncovered third adhesive surface of the second adhesive film to one of the first sorbent layer and the second sorbent layer coupled to the first adhesive film;
removing the second sacrificial liner from the second adhesive film by exposing at least the second sacrificial liner to a second release medium, uncovering the fourth adhesive surface;
forming a third sorbent layer by adhering the particulate sorbent material to the uncovered fourth adhesive surface of the second adhesive film.

12. The method of claim 7, wherein the first adhesive surface and the second adhesive surface comprise pressure sensitive adhesive.

13. The method of claim 7, wherein the adhesive film is composed of a single layer of an adhesive.

14. The method of claim 7, wherein the adhesive film comprises a thin film substrate having a first side and a second side opposite the first side, the adhesive film further comprising a first adhesive layer bonded to the first side and a second adhesive layer bonded to the second side, the first and second adhesive layers forming the first and second adhesive surfaces of the adhesive film, respectively.

15. The method of claim 7, wherein exposing at least the sacrificial liner to the release medium comprises submerging the sacrificial liner, the adhesive film, and the first sorbent layer in the release medium, the release medium being a liquid.

16. The method of claim 7, wherein the sacrificial liner comprises polyvinyl alcohol.

17. The method of claim 7, wherein the release medium is water.

18. The method of claim 7, further comprising perforating the adhesive film before the first release liner has been removed such that the adhesive film comprises a plurality of apertures allowing an air flow to pass through.

19. The method of claim 7, wherein the adhesive film is between 10 μm and 250 μm thick.

20. The method of claim 7, wherein the particulate resin material has a diameter less than 200 μm.
